(19) United States
(12) Patent Application Publication
(10) Pub. No.: US 2008/0141226 A1
(43) Pub. Date: Jun. 12, 2008

(54) SYSTEM AND METHOD FOR CONTROLLING TRACE POINTS UTILIZING SOURCE CODE DIRECTORY STRUCTURES

(76) Inventors: Janice M. Girouard, Austin, TX (US); Claudia A. Salzberg, Austin, TX (US); Michael T. Strosaker, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/608,880

(22) Filed: Dec. 11, 2006

(51) Int. Cl. G06F 9/44

(52) U.S. Cl. 717/128

(57) ABSTRACT

A system and method for controlling trace points utilizing source code directory structures. According to an embodiment of the present invention, a debug engine sets a debug level to a default debug level for an application to be debugged, wherein said application includes a collection of files organized within a collection of directories. A debug utility creates a set of trace point selections by selecting at least one file among the plurality of files in the first directory for debug when a first directory among the collection of directories is evaluated. The debug utility enables at least one trace point within the at least one file. The debug engine debugs the application according to the set of trace point selections and the debug level selected.

### BACKGROUND OF THE INVENTION

1. Technical Field

The present invention relates in general to the field of data processing systems, and more specifically, the field of tracing program flows utilizing a data processing system.

2. Description of the Related Art

Tracing is an important part of software development. Conventional tracing allows an application programmer or user to analyze the flow of data through the processing logic of the software. In particular, tracing statements may be added to the program source code to indicate the status of variables and other indicators at the entry and exit of a function. Tracing may also indicate the status of variables when an exception occurs. By including tracing options in a product, the product offers an increased level of serviceability to its customers.

There are two general, conventional approaches to trace statement insertion. First, there is the manual approach, which involves going through source code and manually inserting trace statements. Second, there are trace statement insertion programs that facilitate the insertion of trace statements into source code.

Manual insertion of entry, exit, and exception trace statements typically requires significant time and effort on the part of the programmer. Even with the use of tools to aid in the process (for example, the Eclipse/Websphere Application Developer (WSAD) Reusable Asset (RAS) plug-in, in the case of Java code), manual insertion of trace statements required a significant amount of developmental time and effort, and is also subject to human error. Manual trace statement insertion allows, for example, misspelled function or method names and overlooked classes. Minor mistakes can significantly impact product serviceability. Manual trace statement insertion also requires substantial code management and maintenance. Changes in function names or the addition of new functions makes it difficult to track the portions of the program code that include trace statements and the extent to which the trace statements are implemented. Manual trace statement insertion generates undesirable clutter in the source code. Also, the addition of trace statements increases the size of the source code and increases the difficulty of later review of the source code, if necessary.

To manage the insertion of trace statements, it is well-known in the art that there are trace statement insertion programs that facilitate the insertion of trace statements by looking for keywords in the program code that often trigger the insertion of a trace statement. Once the trace statements (hereinafter referred to as “trace points”) are inserted into the source code, there is a need for a system and method for managing the trace points. Since each trace point consumes system resources, it is important that the utilization of trace points is monitored. Therefore, due to the limitations of the prior art, there is a need to intelligently, yet automatically, enable trace points on a running data processing system when information about a particular application under debug is limited.

### SUMMARY OF THE INVENTION

The present invention includes a system and method for controlling trace points utilizing source code directory structures. According to an embodiment of the present invention, a debug engine sets a debug level to a default debug level for an application to be debugged, wherein said application includes a collection of files organized within a collection of directories. A debug utility creates a set of trace point selections by selecting at least one file among the plurality of files in the first directory for debug when a first directory among the collection of directories is evaluated. The debug utility enables at least one trace point within the at least one file. The debug engine debugs the application according to the set of trace point selections and the debug level selected.

After the debug engine debugs the application, the debug results are presented via the debug utility to enable trace point selection optimization. If the trace point selections are optimized, the debug utility sends the optimized trace point selections back to the debug engine for debug processing.

The above, as well as additional purposes, features, and advantages of the present invention will become apparent in the following detailed written description.

### BRIEF DESCRIPTION OF THE FIGURES

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying figures, wherein:

FIG. 1 is a block diagram illustrating an exemplary data processing system in which an embodiment of the present invention may be implemented;

FIG. 2 is a block diagram depicting exemplary contents of a system memory according to an embodiment of the present invention;

FIGS. 3A-3K are pictorial representations of selection menus presented by a GUI as illustrated in FIG. 2;

FIG. 4 is a high-level logical flowchart illustrating an exemplary method of presenting options via selection menus to facilitate trace point control utilizing source code directory structures; and

FIG. 5 is a high-level logical flowchart depicting exemplary operation of a debug engine according to an embodiment of the present invention.

### DETAILED DESCRIPTION OF AN ILLUSTRATIVE EMBODIMENT

The present invention includes a system and method for controlling trace points utilizing source code directory structures. According to an embodiment of the present invention, a debug engine sets a default debug level for an application or kernel to be debugged. A debug utility sends debug parameters to define a scope for the debug engine to perform the debug operation, which may be performed at a directory-level, individual file-level, or individual trace point-level. Once the debug operation is performed, the results of the debug operation are presented to a user.

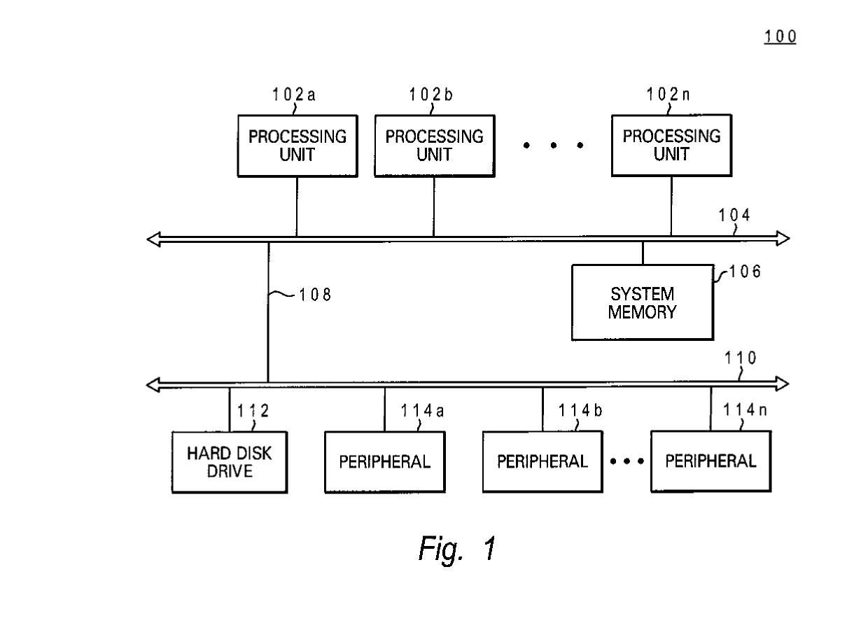

Referring to the figures, and more particularly, referring now to FIG. 1, there is illustrated a block diagram of an exemplary data processing system 100 in which an embodiment of the present invention may be implemented. As depicted, exemplary data processing system 100 includes processor(s) 102a-102n, which are coupled to system memory 106 via system bus 104. Preferably, system memory 106 may be implemented as a collection of dynamic random access memory (DRAM) modules. Mezzanine bus 108 acts as an intermediary between system bus 104 and peripheral bus 110. Those with skill in this art will appreciate that peripheral bus 110 may be implemented as a peripheral component interconnect (PCI), accelerated graphics port (AGP), or any other peripheral bus. Coupled to peripheral bus 110 is hard disk drive 112, which is utilized by data processing system 100 as a mass storage device. Also coupled to peripheral bus 110 is a collection of peripherals 114a-114n.

Those skilled in the art will appreciate that data processing system 100 can include many additional components not specifically illustrated in FIG. 1. Because such additional components are not necessary for an understanding of the present invention, they are not illustrated in FIG. 1 or discussed further herein. It should also be understood, however, that enhancements to data processing system 100 for selecting trace points for tracing an application and for assigning a relative priority to each trace point, which are provided by the present invention, are applicable to data processing systems of any system architecture and are in no way limited to the generalized multi-processor architecture illustrated in FIG. 1.

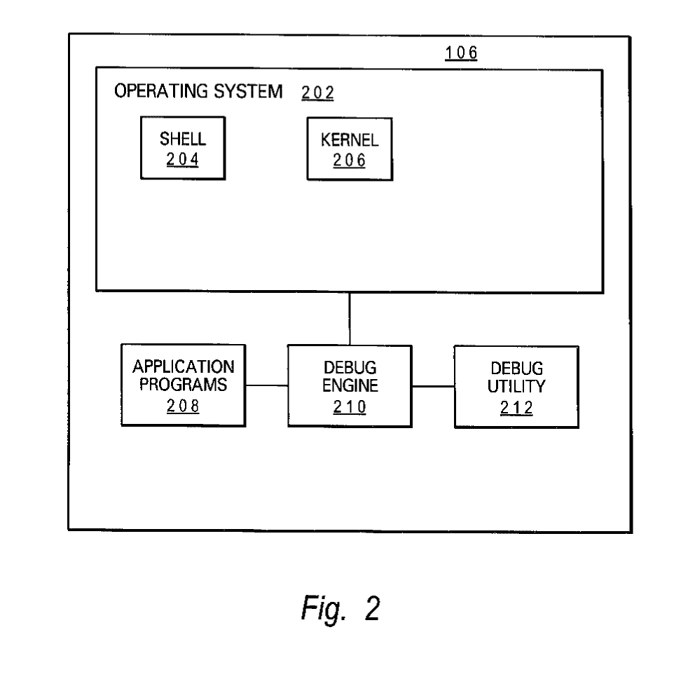

FIG. 2 is a block diagram illustrating exemplary contents of system memory 106 of data processing system 100 according to an embodiment of the present invention. As depicted, system memory 106 includes operating system 202, which further includes shell 204 for providing transparent user access to resources such as application programs 208. Generally, shell 204 (as it is called in Linux), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., kernel 206) for processing. Note that while shell 204 is a text-based, line-oriented user interface, the present invention will support other user interface modes, such as graphical, voice, gestural, etc. equally well.

As illustrated, operating system 202 also includes kernel 206, which provides lower levels of functionality for operating system 202, including providing essential services required by other parts of operating system 202 and application programs 208, including memory management, process and task management, disk management, and mouse and keyboard management. Application programs 208 can include a browser, utilized for access to the Internet, word processors, spreadsheets, and other application programs. Also, as depicted, system memory 106 includes a debug engine 210 and debug utility 212, which interfaces with kernel 206 or a program within application programs 208 for controlling trace points utilizing source code directory structures, in accordance with an embodiment of the present invention.

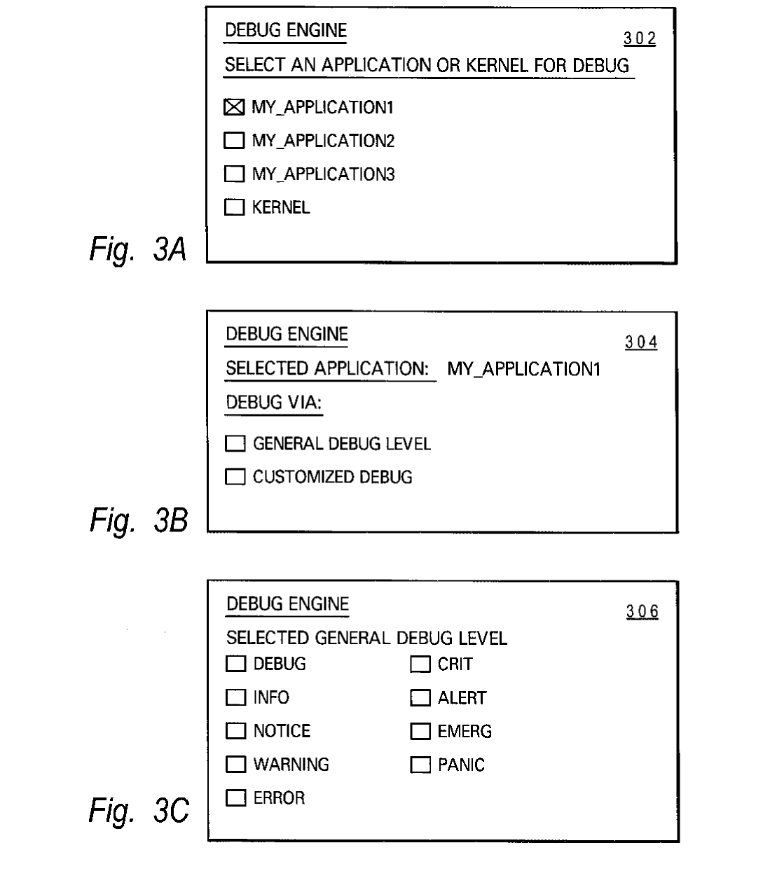

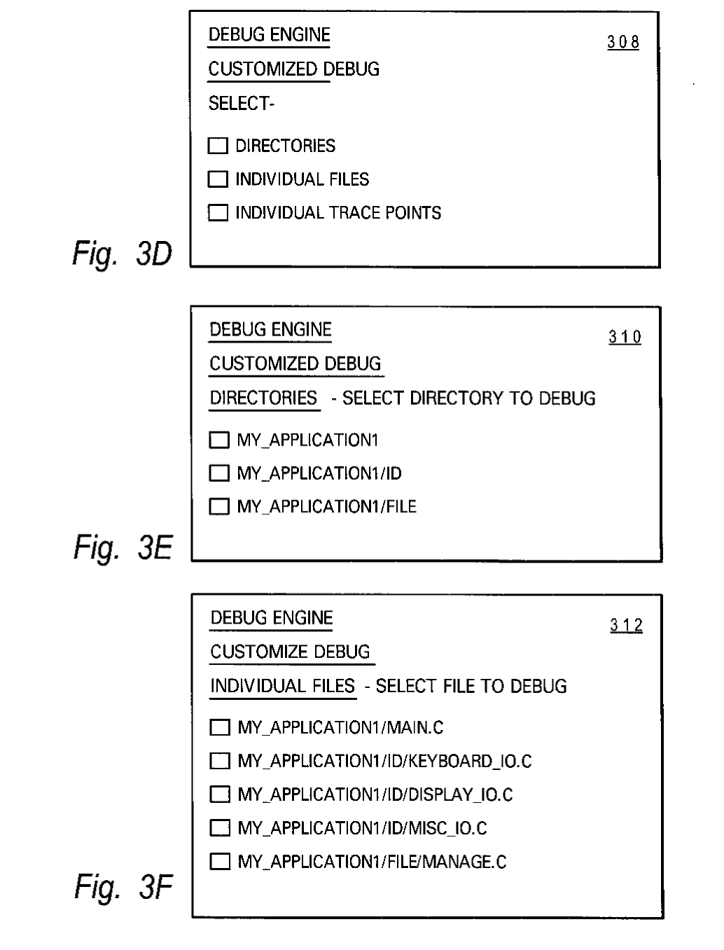

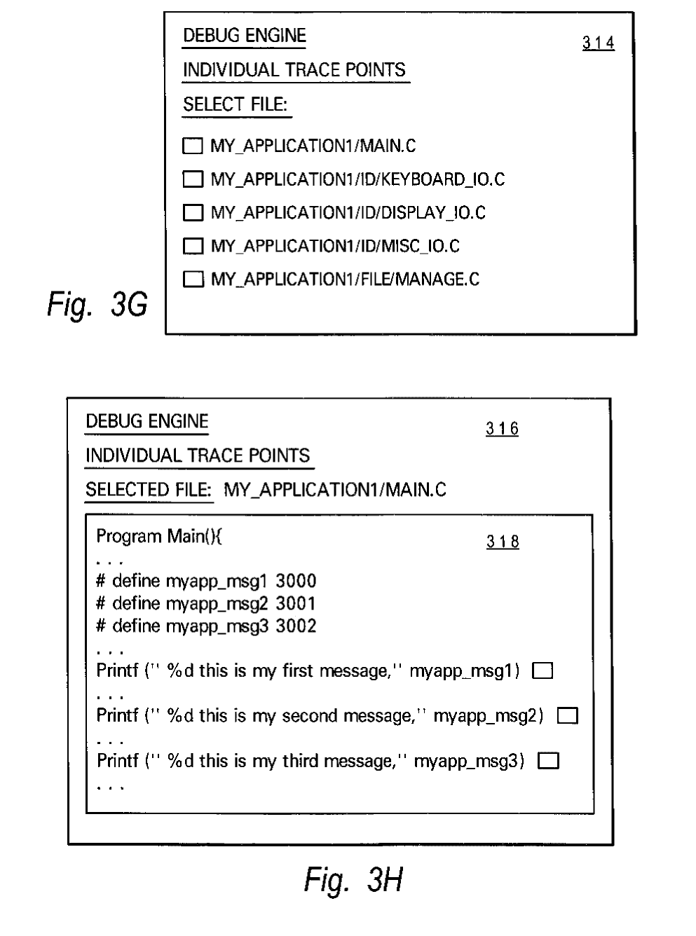

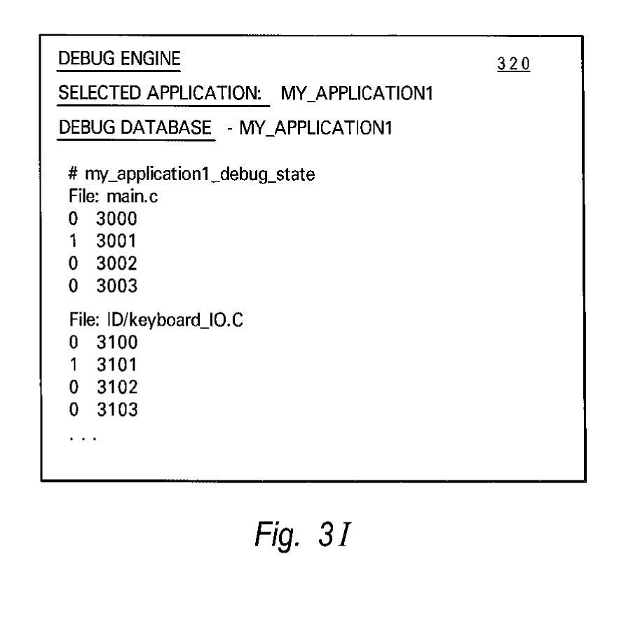

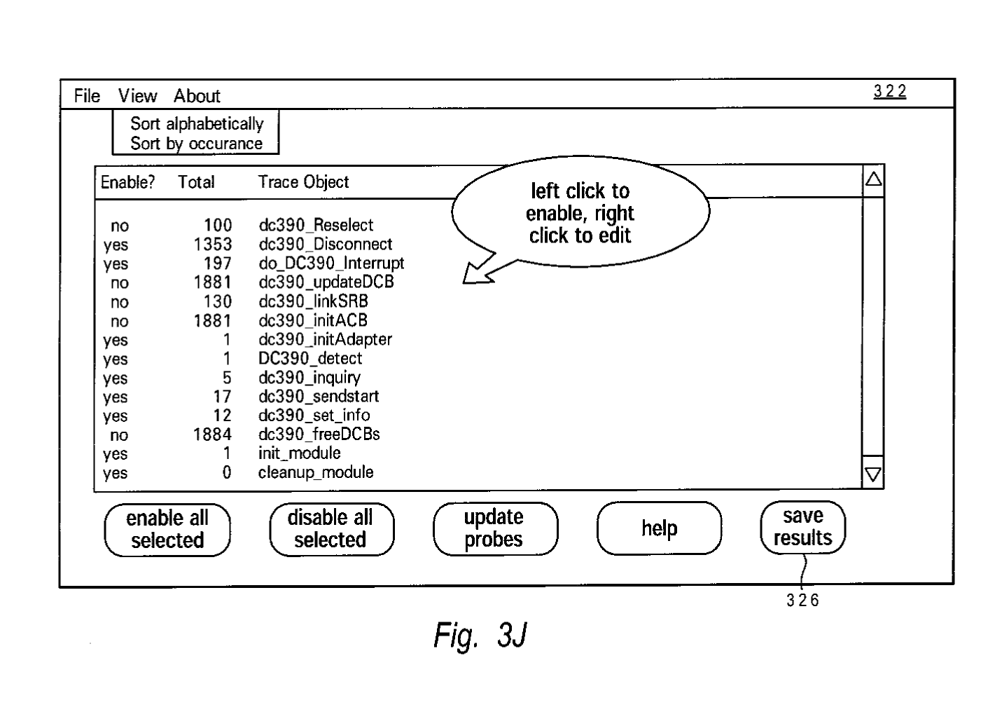

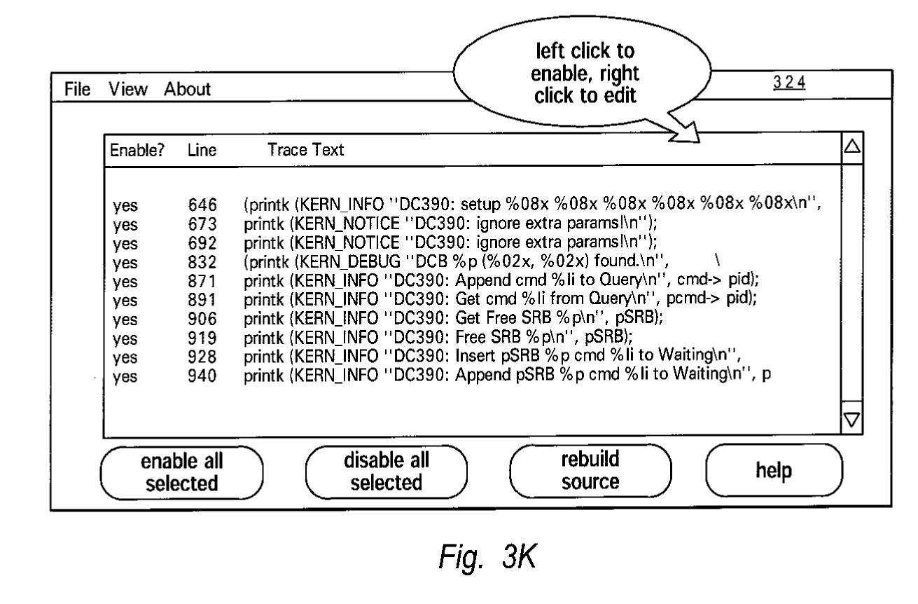

As discussed herein in more detail, the relationship between application programs 208, debug engine 210, and debug utility 212 is as follows. Debug utility 212 acts as an interface to debug engine 210, which enables a user to activate or deactivate trace points within kernel 206 or an application program 208. Generally, debug utility 212 generates a collection of selection menus (FIGS. 3A-3K) to enable a user to adjust the scope of the application or kernel debug function. As previously discussed, trace points may be inserted in kernel 206 or an application program 208 via manual insertion of trace points or the utilization of a trace point insertion program. Once the trace points are inserted into kernel 206 or application program 208, the trace points may be activated or deactivated, depending on the user-defined scope of the application or kernel debug function.

Since application programs 208 and kernel 206 are preferably organized in a file system, debug engine 210 enables a user to specify files, directories, or entire programs in which trace points are activated or deactivated. An example of a trace point (for example, in the C programming language) would be a “print” statement that the user or software developer to determine the current value of a certain variable during program execution. Examples of trace points are shown in FIG. 3H.

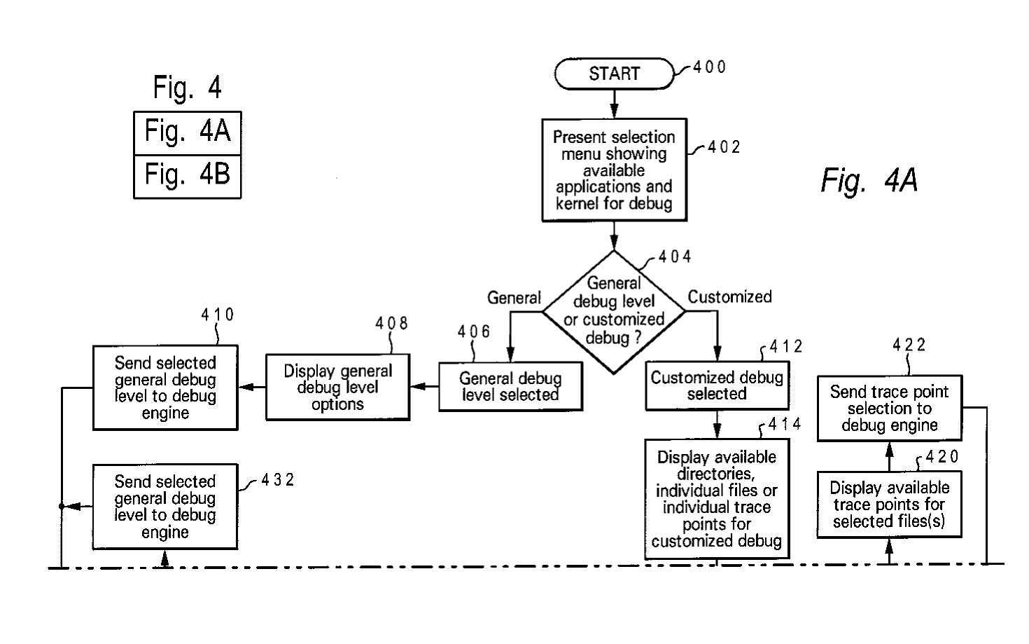

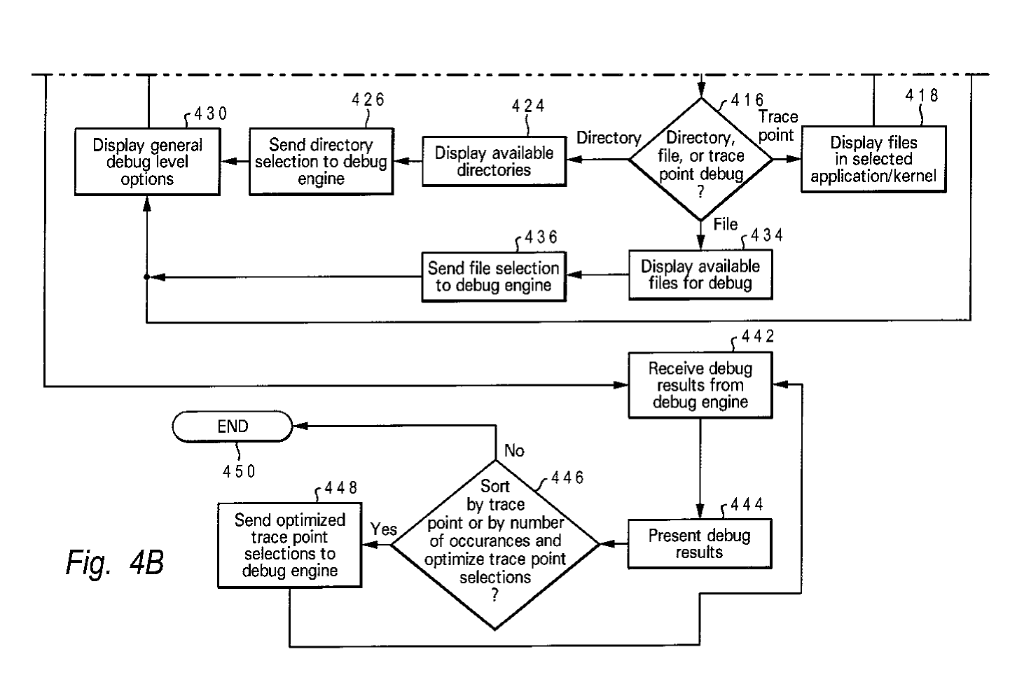

FIG. 4 is a high-level logical flowchart illustrating exemplary operation of debug utility 212 according to an embodiment of the present invention. For the purposes of discussion, FIG. 4 will be discussed in conjunction with the selection menus of debug utility 212 as depicted in FIGS. 3A-3K.

Generally, debug utility 212 presents a collection of selection menus to enable a user to adjust the scope of the application or kernel debug function, depending on a set of preferences. The first selection identifies the application or kernel that will be the target of the debug operation (FIG. 3A).

Next, a selection is made to determine whether the debug function will be carried out utilizing a generalized debug setting or a customized setting (FIG. 3B). The generalized debug setting is based on a selected debug level, discussed herein in more detail in conjunction with FIG. 3C.

If the user selects the “customized debug” option, debug utility 212 presents a customized debug selection menu 308 (FIG. 3D), which enables the user to select the scope of the customized debug operation (e.g., directory-wide or narrowed to an individual file or trace point). If the user has selected the “directory” or “individual file” option, debug utility 212 presents a directory selection menu 310 (FIG. 3E) or a file selection menu 312 (FIG. 3F), respectively to enable the user to select a specific directory or individual file as the target of the debug operation. Debug utility 212 presents generalized debug level selection menu 306 (FIG. 3C) to prompt the user to select a generalized debug level to process either the selected directory or individual file in a debug operation.

If the user has selected the “individual trace point” option, debug utility 212 enables the user to enable or disable specific trace points within the files of the application or kernel selected for a debug operation (FIGS. 3G and 3H). All of the available trace points and their current status (activated/deactivated) are accessible to the user via a debug database 320, as shown in FIG. 3I.

One debug engine 210 has completed the trace point processing, debug utility 212 receives the results. The results of the processing (shown as log entries) can be sorted by trace point or by the number of occurrences (FIG. 3J). A user can also optimize the trace point settings by selecting/deselecting trace points in FIG. 3J. For example, if a trace point results in too many log entries, that particular trace point may be considered a “noisy” trace point that clutters the results. In this case, the noisy trace point may be deselected. The user may also select/deselect the actual trace points as shown in FIG. 3K.

Referring back to FIG. 4, the process begins at step 400 and continues to step 402, which depicts debug utility 212 presenting to a user an application or kernel selection menu 302 (FIG. 3A) that displays a collection of applications and kernels available for debug. Once the user has selected the desired application or kernel for debug, the process continues to step 404, which illustrates debug utility 212 presenting a choice between a “general debug level” and “customized debug” within a debug options selection menu 304 (FIG. 3B). If “general debug level” is selected in debug options selection menu 304, as illustrated in step 406, the process proceeds to step 408, which shows debug utility 212 displaying general debug level selection menu 306, as depicted in FIG. 3C.

General debug selection menu 306 includes a collection of debug levels controlled by a system log utility (e.g., syslog in Linux). The system log utility logs system messages, including messages generated by trace points within applications 208 or kernel 206 according to a set of predetermined rules. The predetermined rules include a priority field (e.g., debug, info, notice, warning, warn, err, error, crit, alert, emerg, panic, etc.) that defines the severity of the particular system message. The system log utility logs all messages of a certain priority or higher. The debug levels are tied to the priority fields so that the system messages are logged by the system log utility depending on the particular priority setting of a system message. Generally, the higher the selected debug level, the more trace points are enabled for monitoring in the selected application 208 or kernel 206.

Once debug utility 212 has received a selection from debug level selection menu 306, the process continues to step 410, which illustrates debug utility 212 sending the selected general debug level to debug engine 210 for processing. The process continues to step 442, which will be discussed herein in more detail.

Returning to step 404, if “customized debug” is selected (step 412), the process continues to step 414, which depicts debug utility 212 displaying a customized debug selection menu 308 (FIG. 3D). A selection of “customized debug” enables a user to narrow the scope of the debug operation at a directory, individual file, or individual trace point level. As illustrated, customized debug selection menu 308 includes three choices for trace point activation/deactivation by directory, individual file, or individual trace point, as shown in steps 414 and 416.

If debug utility 212 receives, via customized debug level selection menu 308, a selection of “directories”, the process continues to step 424, which shows debug utility 212 (via directory selection menu 310 in FIG. 3E) displaying all directories that include files associated with the application or kernel selected in step 402. Once debug utility 212 receives the selections for directories for debug via directory selection menu 310, the process continues to step 426, which illustrates debug utility 212 sending the directory selections to debug engine 210.

Once the user has selected the directories for debug, debug utility 212 will prompt the user to select a generalized debug level to apply to the selected directories (via general debug level selection menu 306), as illustrated in step 430. For example, a user may want to only debug the files located in the directory “my_application1/io” at a “notice” generalized debug level. Once the user has selected the desired generalized debug level, debug utility 212 sends the selected generalized debug level to debug engine 210, as depicted in step 432. Then, the process continues to step 442, which will be discussed herein in more detail.

Returning to step 416, if debug utility receives, via customized debug level selection menu 308, a selection of “individual files”, the process continues to step 434, which depicts debug utility 212 (via file selection menu 312 in FIG. 3F) displaying all files associated with the application or kernel selected in step 402. The process continues to step 436, which shows debug utility 212 sending the selected files for debug to debug engine 210.

Once the user has selected the files for debug, debug utility 212 will prompted the user to select a generalized debug level to apply to the selected files (via general debug level selection menu 306), as illustrated in step 430. For example, a user may want to only debug files “my_application1/main.c” and “my_application1/io/keyboard_io.c” at a “notice” generalized debug level. Once the user has selected the desired generalized debug level, debug utility 212 sends the selected generalized debug level to debug engine 210, as depicted in step 432. Then, the process continues to step 442, which will be discussed herein in more detail.

Returning to step 416, if debug utility 212 receives, via customized debug level selection menu 308, a selection of “individual trace points”, the process continues to step 418, which illustrates debug utility 212 (via file selection menu 314 in FIG. 3G) displaying all files associated with the application or kernel selected in step 402. After the desired files are selected, the process proceeds to step 420, which shows debug utility 212 displaying trace point selection menu 316 and file source code 318 as illustrated in FIG. 3H. After the desired trace points are selected debug utility 212 sends the selected trace points to debug engine 210 for processing, as shown in step 422. The process proceeds to step 430 and 432, which depicts debug utility 212 prompting the user to select a generalized debug level to apply to the rest of the files in the application or kernel. Once the generalized debug level is selected, debug utility 212 sends the selection to debug engine 210. Debug engine 210 then performs trace point processing on the selected application or kernel based on the trace point selections.

After debug engine 210 completes the trace point processing based on the trace point selections sent in step 422, the process continues to step 442, which illustrates debug utility 212 receiving the debug results from debug engine 210. The process proceeds to step 444, which depicts debug utility 212 presenting the debug results from debug engine 210, as shown in FIG. 3J. Result log menu 322 enables a user to sort the logged results by trace point or by the number of occurrences. If desired, the trace point processing results may be saved in a file for later use, and/or be the initial starting point for a later trace point processing run. To save the results, the user can select the “save results” option 326.

The user can also optimize the trace point selections by selecting/deselecting trace points based on their number of occurrences, as illustrated in step 446. For example, a log in the results such as “dc390_freeDCBs”, which generated 1884 results, may be considered a “noisy result”. In future trace point processing, the user may want to deactivate “dc390_freeDCBs” to prevent cluttering the results. Also, if a particular log in the results include multiple individual trace points, the user may select/deselect the individual trace points via trace point selection menu 324. Trace point selection menu 324 may be reached by selecting a particular log entry in result log menu 322.

If debug utility 212 receives a command to not sort the results and optimize trace point selections, the process proceeds to step 450, which illustrates the process ending. If debug utility 212 receives a command to sort the results and optimize trace point selections, the sorting and optimization is performed. The optimized trace point selections are sent back the debug engine 210 for further processing, as depicted in step 448. The process then returns to step 442 and proceeds in an iterative fashion.

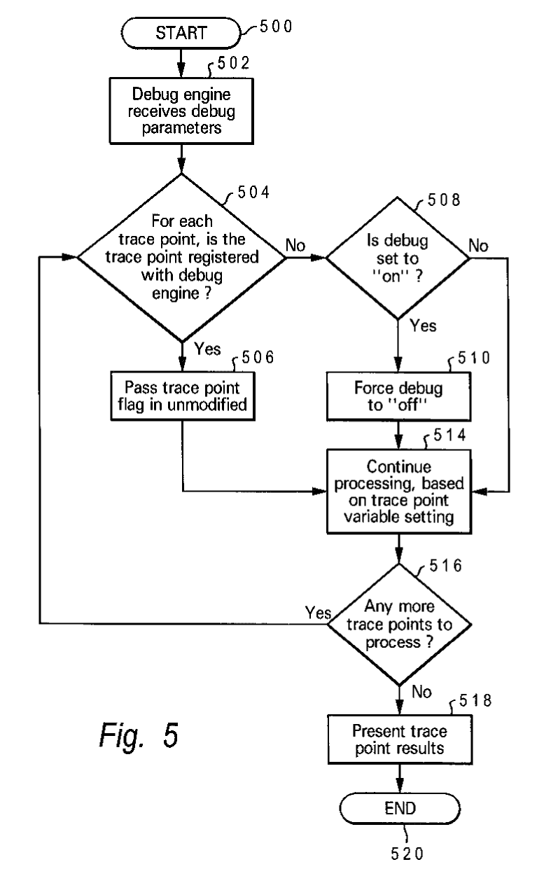

FIG. 5 is a high-level logical flowchart depicting exemplary operation of debug engine 210 according to an embodiment of the present invention. The process begins at step 500, and continues to step 502, which shows debug engine 210 receiving the debug parameters from debug utility 212. The process proceeds to step 504, which illustrates debug engine 210 determining if each activated trace point (specified in the debug parameters) is registered with debug engine 210. The registration of trace points occurs when the debug parameters, which specify which trace points will be activated/deactivated, are received by debug engine 210. The registration process includes parsing the program file for trace points, and assigning each trace point with a reference numeral, as previously discussed in conjunction with FIGS. 3H and 3I.

If the current trace point is registered with debug engine 210, the process continues to step 506, which depicts debug engine 210 enabling each trace point in the file to be handled as specified by debug database 210. The process then continues to step 514, which illustrates debug engine 210 processing each trace point, based on the settings in debug database 320.

The process proceeds to step 516, which depicts debug engine 210 determining if there are any more trace points to process. If there are more trace points to process, the process returns to step 504 and proceeds in an iterative fashion. If there are no more trace points to process, the process continues to step 518, which illustrates debug engine 210 presenting the results of the debug operation via a variety of methods, including, but not limited to: (1) a results screen (e.g., results log menu 302 in FIG. 3J) displayed by debug utility 212, (2) outputting the results in a file, (3) or some other method of presenting debug results. Then, the process ends, as illustrated in step 520.

Returning to step 504, if the current trace point is not registered with debug engine 210, which illustrates debug engine 210 determining whether or not debug is set to “on” (or whether the trace point is active). If debug is set to “on”, as depicted in step 508, the process continues to step 510, which illustrates debug engine 210 deactivating the trace point (forcing the debug to “off” for the particular trace point). The process then continues to step 514. If the debug not set to “on”, the process continues to step 514. The debug value (set to “on” or “off”) is a default debug value established in step 406 and 432, where a generalized debug level is selected by the user. If the individually configured debug setting for a particular trace point is unknown, the default value is the debug value established in the generalized debug level selection in steps 406 and 432.

As discussed, the present invention includes a system and method for controlling trace points utilizing source code directory structures. According to an embodiment of the present invention, a debug engine sets a debug level to a default debug level for an application to be debugged, wherein said application includes a collection of files organized within a collection of directories. A debug utility creates a set of trace point selections by selecting at least one file among the plurality of files in the first directory for debug when a first directory among the collection of directories is evaluated. The debug utility enables at least one trace point within the at least one file. The debug engine debugs the application according to the set of trace point selections and the debug level selected.

It should be understood that at least some aspects of the present invention may alternatively be implemented as a program product. Program code defining functions in the present invention can be delivered to a data storage system or a computer system via a variety of signal-bearing media, which include, without limitation, non-writable storage media (e.g., CD-ROM), writable storage media (e.g., hard disk drive, read/write CD-ROM, optical media), system memory such as, but not limited to Random Access Memory (RAM), and communication media, such as computer and telephone networks including Ethernet, the Internet, wireless networks, and like network systems. It should be understood, therefore, that such signal-bearing media when carrying or encoding computer-readable instructions that direct method functions in the present invention represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention.

What is claimed is:

1. A computer-implementable method comprising:
setting a debug level to a default debug level for an application to be debugged, wherein said application includes a plurality of files organized within a plurality of directories;
when a request to alter said debug level is received, altering said debug level to an alternate debug level;
creating a set of trace point selections by:
when a first directory among said plurality of directories is evaluated, selecting at least one file among said plurality of files in said first directory for debug;
enabling at least one trace point within said at least one file; and
debugging said application according to said set of trace point selections and said default debug level.

2. The computer-implementable method according to claim 1, further comprising:
selecting at least one directory about said plurality of directories to enable all trace points within all files included in said at least one directory.

3. The computer-implementable method according to claim 1, wherein said default debug level is applied to all trace points not specifically defined in said set of trace point selections.

4. The computer-implementable method according to claim 1, further comprising:
presenting a set of debug results after said debugging; and
optimizing said set of trace point selections.

5. The computer-implementable method according to claim 4, wherein said optimizing further includes:
sorting said set of debug results; and
disabling at least one trace point among said set of trace point selections.

6. A data processing system comprising:
a processor;
a databus coupled to said processor;
a computer-usable medium embodying computer program code, said computer program code comprising instructions executable by said at least one processor and configured for:
setting a debug level to a default debug level for an application to be debugged, wherein said application includes a plurality of files organized within a plurality of directories;
when a request to alter said debug level is received, altering said debug level to an alternate debug level;
creating a set of trace point selections by:
when a first directory among said plurality of directories is evaluated, selecting at least one file among said plurality of files in said first directory for debug;
enabling at least one trace point within said at least one file; and
debugging said application according to said set of trace point selections and said default debug level.

7. The data processing system according to claim 6, wherein said computer program code further comprises instructions configured for:
selecting at least one directory about said plurality of directories to enable all trace points within all files included in said at least one directory.

8. The data processing system according to claim 6, wherein said default debug level is applied to all trace points not specifically defined in said set of trace point selections.

9. The data processing system according to claim 6, wherein said computer program code further comprises instructions configured for:
presenting a set of debug results after said debugging; and
optimizing said set of trace point selections.

10. The data processing system according to claim 9, wherein said optimizing further includes:
sorting said set of debug results; and
disabling at least one trace point among said set of trace point selections.

11. A computer-usable medium embodying computer program code, said computer program code comprising computer executable instructions configured for:
setting a debug level to a default debug level for an application to be debugged, wherein said application includes a plurality of files organized within a plurality of directories;
when a request to alter said debug level is received, altering said debug level to an alternate debug level;
creating a set of trace point selections by:
when a first directory among said plurality of directories is evaluated, selecting at least one file among said plurality of files in said first directory for debug;
enabling at least one trace point within said at least one file; and
debugging said application according to said set of trace point selections and said default debug level.

12. The computer-usable medium according to claim 11, wherein said embodied computer program code further comprises computer executable instructions configured for:
selecting at least one directory about said plurality of directories to enable all trace points within all files included in said at least one directory.

13. The computer-usable medium according to claim 11, wherein said default debug level is applied to all trace points not specifically defined in said set of trace point selections.

14. The computer-usable medium according to claim 11, wherein said embodied computer program code further comprises computer executable instructions configured for:
presenting a set of debug results after said debugging; and
optimizing said set of trace point selections.

15. The computer-usable medium according to claim 14, wherein said optimizing further includes:
sorting said set of debug results; and
disabling at least one trace point among said set of trace point selections.
